(19) United States
(12) Patent Application Publication
(10) Pub. No.: US 2025/0263335 A1
(43) Pub. Date: Aug. 21, 2025

(54) PROCESS AND APPARATUS FOR SLAKING LIME

(71) Applicant: RDP Technologies, Inc., Conshohocken, PA (US)

(72) Inventors: Robert Christy, III, Wayne, PA (US); Michael Quici, Ambler, PA (US); Louis Litz, Ambler, PA (US)

(21) Appl. No.: 19/058,377

(22) Filed: Feb. 20, 2025

Related U.S. Application Data
(60) Provisional application No. 63/555,976, filed on Feb. 21, 2024.

(51) Int. Cl. C04B 2/06; C02F 1/52; C04B 2/08

(52) U.S. Cl. CPC C04B 2/066; C02F 1/529; C04B 2/08

(57) ABSTRACT

Lime is slaked with process water. The process water is preheated by circulating the process water through a water jacket which surrounds the staking vessel. Subsequently, unheated process water is mixed with the preheated water. The mixture can be varied in order to adjust the water temperature to within a desired range.

### CROSS REFERENCE TO RELATED APPLICATION

The present application claims the priority of U.S. Provisional Patent Application 63/555,976, filed Feb. 21, 2024, which is incorporated herein by reference in the entirety.

### BACKGROUND OF THE INVENTION

### 1. Field of the Invention

The present invention relates to processes and apparatus for hydrating or “slaking” calcium oxide.

### 2. Brief Description of the Prior Art

Slaked lime is an important material used in various industrial processes, including the purification of water as well as the treatment of wastewater. Lime has been used in the treatment of sewage sludge to remove pathogens, for the lime stabilization of wastewater, and for the pasteurization of sludge and purification of drinking water by adjusting the pH of the water. Examples of such processes involving the use of lime can be found in U.S. Pat. Nos. 5,013,458; 5,229,011; 5,346,616; 5,401,402; 5,405,536; 5,433,844; 5,554,279; 5,618,442; 7,416,673, and 9,856,166, which are incorporated herein by reference.

Calcium oxide (CaO) is mixed with water (H₂O) to form calcium hydroxide (Ca(OH)₂). The chemical reaction which occurs during such mixing gives off heat in the form of an exothermic reaction. When this reaction is done in the presence of excess water, it is commonly referred to as lime slaking. This process is accomplished in a device known as a lime slaker. The resulting mixture of Ca(OH)₂ and water is known as a lime slurry.

U.S. Pat. No. 9,856,166, incorporated herein by reference, describes a lime slaking system including a lime slaker including a mixing vessel which receives lime from a lime storage silo and fitted with a water jacket. Process water flows through the water jacket and is subsequently sprayed on lime in the mixing vessel. Heat from the hydration reaction inside the mixing vessel is transferred to water circulating through the water jacket to preheat the water to about 10 to 20 degrees Fahrenheit above the ambient temperature of the process water. The process water may be circulated through another water jacket, such as one fitted to a slurry aging tank, to further preheat the process water. Lime slurry from the lime slaker is transferred to the slurry aging tank before use in water treatment, and residual heat in the lime slurry serves to heat the process water circulating in the water jacket of the slurry aging tank.

While the slaking process can be controlled using a programmable logic computer, it can be difficult to attain the desired temperature range for the slaking water, as the temperature of the process water can vary substantially through the seasons of the years. In particular, during the warmer months, the preheated process water may be warmer than desirable, reducing the efficiency of the slaking process.

The particle size of the slaked lime produced during slaking can be an important as a measure of the activity or utilization efficiency of the slaked lime. Since the particle size of the slaked lime decreases with increasing slaking temperature, producing a product with increased particle surface area and concomitant increased reactivity, lime is often slaked at as elevated a temperature as possible given practical considerations.

### SUMMARY OF THE INVENTION

The present invention provides a process for slaking lime. The present invention permits selecting a target temperature which can be maintained year-round. Thus, the present invention allows an optimal slaking temperature, a target temperature, and at a highly effective slaking reaction the entire year-round.

In the process, an initial target temperature for the slaking water is determined.

In one aspect of the process of the present invention, an initial target or initial setpoint temperature is calculated based on physical characteristics of the lime to be slaked. In the alternative or in addition, the initial target temperature can reflect the operational characteristics of the slaker.

In one presently preferred embodiment, the initial target temperature is determined empirically. Preferably, the initial target temperature is calculated, preferably from the value of the final slaking temperature setpoint of at least one earlier batch, the final lime slurry batch concentration setpoint of at least one earlier batch, and the measured lime reactivity of the most recent batch.

The process is preferably practiced with a slaking vessel having a first compartment and a second compartment in which the first and second compartments are disposed to permit heat exchange between the compartments. The process includes mixing slaking water with lime in the first compartment, and providing water, such as process water, to the second compartment, whereby heat generated by the exothermic slaking of lime in the first compartment is transferred to the input water. Preferably, the process further includes drawing water heated in the second compartment and optionally measuring the temperature of the water heated in the second compartment.

The process preferably further includes providing process water to be mixed with water heated in the second compartment, and, optionally, measuring the temperature of the process water.

The process also preferably includes mixing the water heated in and drawn from the second compartment with water, such as process water, in proportion to provide water at the target temperature, and measuring the temperature of the mixture of water drawn from the second compartment and the added process water. The process preferably includes providing the water at the target temperature to the first compartment to slake the lime.

Preferably, the first compartment of the slaking vessel has an exterior surface and the second compartment jackets at least a portion of the exterior surface of the first compartment. Thus, in one aspect, the process comprises heating the water input to the second compartment.

In a presently preferred embodiment, the process further comprises providing a slurry aging tank or “day tank” having a third compartment for receiving slaked lime from the first compartment and fourth compartment for circulating water, wherein the third and fourth compartments are disposed to permit heat exchange between the third and fourth compartments. The process further comprises transferring slaked lime from the first compartment to the third compartment. Preferably, in this embodiment, the process further comprises providing process water to the fourth compartment, wherein heat generated by the aging lime slurry is transferred to the process water in the fourth compartment. Preferably, the process further includes drawing process water heated in the fourth compartment and providing the water drawn from the fourth compartment to the second compartment, to preheat the water input to the second compartment.

Preferably, the process also preferably includes providing means for controlling the flow of process water provided to the mixing device, and/or means for controlling the flow of water drawn from the second compartment and provided to the mixing device.

The process also preferably includes adjusting the flow rate of the water drawn from the second compartment, the flow rate of the added process water, or both. Preferably, the process includes preferably includes adjusting the flow rate of the water drawn from the second compartment, the flow rate of the added process water, or both, based on the temperature of the mixture of the water drawn from the second compartment and added process water.

Preferably, the flow rates of the water drawn from the second compartment and the flow rate of the added process water are controlled by valves, such as pinch valves or the like.

The present invention also provides apparatus for slaking lime comprising a slaking vessel having a first compartment for slaking lime with water and a second compartment having a fluid input and a fluid output, the first and second compartments being disposed to permit heat exchange between the compartments, such that heat generated by the exothermic slaking of lime is transferred to fluid in the second compartment.

The apparatus also provides means for drawing water from the second compartment. The apparatus also preferably includes means for providing process water, as well as optional means for measuring the temperature of the process water.

The apparatus also preferably includes means for mixing the water drawn from the second compartment with the process water. Preferably, the apparatus also includes means for adjusting the flow rate of water drawn from the second compartment. Preferably, the apparatus also includes means for adjusting the flow rate of process water.

Preferably, the apparatus also includes means for determining the proportion of process water being mixed with the water drawn from the second compartment required to provide slaking water having a target temperature. Preferably, the apparatus also includes means for providing the slaking water to the first compartment. Preferably, the first compartment comprises a mixing vessel and the second compartment comprises a jacket enveloping at least a portion of the mixing vessel.

Preferably, the means for measuring the temperature of the mixture of the water drawn from the second compartment and the added process water comprises a temperature sensor such as a thermocouple or thermistor. Preferably, the means for measuring the temperature of the process water comprises a temperature sensor such as a thermocouple or thermistor. Preferably, the means for mixing the water drawn from the second compartment with the process water comprises a wye joint.

Preferably, the means for adjusting the flow rate of the water drawn from the second compartment comprises a valve. Preferably, the means for adjusting the flow rate of the process water comprises a valve, such as a pinch valve. Preferably, the process water is pressurized.

In a presently preferred embodiment, the apparatus further comprises a lime slurry aging tank or “day” tank, the slurry aging tank including a third compartment for receiving slaked lime from the first compartment and a fourth compartment for receiving process water, the third and fourth compartments being disposed to permit heat exchange between the third and fourth compartments. Preferably, the apparatus further comprises means for providing process water to the fourth compartment. Preferably, the apparatus further comprises means for transferring process water from the fourth compartment to the second compartment.

### BRIEF DESCRIPTION OF THE DRAWING

FIG. 1 is a schematic representation of an apparatus for slaking lime according to the present invention.

### DETAILED DESCRIPTION

As used herein, “supersaturated lime suspension” (SLS) is defined to include either lime particles dissolved in water or a suspension of small lime particles in water.

Quicklime is sold in different purity ranges which typically range from the high 70 percents to 93 percent. A “93%” quicklime in composed of 93% pure quicklime and 7% grit/impurities.

The present invention provides warm water slaking will allow for even the lower grades of lime to be more efficiently slaked. Nevertheless, there will always be a limit as the grit/impurities cannot be converted. Thus, although less reactive lime will not provide an optimally elevated initial target temperature, warm water slaking will permit that optimum to be approximated.

Ideally, lime is most efficiently slaked at a temperature as close to boiling as possible, which would provide the smallest particles, with largest surface area, and thus most activity. However, this is not practical for two reasons: First, the lime can “burn” at a too elevated a temperature. Second, a “boil over” could occur from too high a slaking temperature.

The benefits of warm water slaking include:
1) Allowing the reaction to meet target temperature in colder months
2) Reducing surface area which gives more efficient treatment
3) Adding hot water to the lime slaker can accelerate the cycle for improved processing times. Good temperature control is important to achieve high efficiency in the reaction. Improved reaction reduces lime costs.

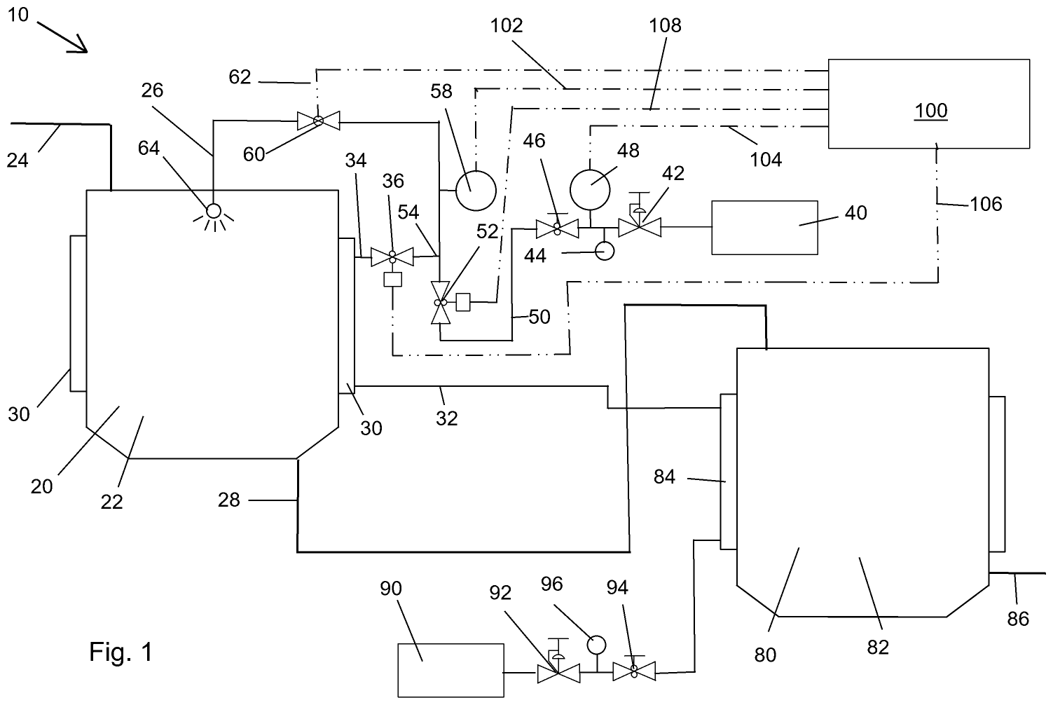

An apparatus for slaking lime 10 according to the present invention is depicted in FIG. 1. The apparatus for slaking lime 10 includes a slaking vessel 20 having a first compartment 22 for receiving lime and a second compartment or water jacket 30 for circulating water around the first compartment 22.

The hydration or “slaking” of lime (calcium oxide) is an exothermic chemical reaction which emits heat. Heat emitted by the reacting lime and slaking water in the first compartment 22 is transferred to the water being circulated in the water jacket 30. Lime is supplied to the first compartment of the slaking vessel 20 through lime input line 24 from a source of lime (not shown), and water for slaking the lime is transferred through a slaking water input line 26 to one or more spray heads 64. Slaked lime is transferred from the slaking vessel 20 through a slaked lime transfer line 28.

The water circulating in the water jacket 30 of the slaking vessel 20 is drawn from the water jacket (“preheat water”) through slaking vessel preheat water line 34, and thence through a preheat water metering valve 36 to a wye joint 54 where the preheat water is mixed with process water. The temperature of the resulting mixture of preheat water and process water (“slaking water”) is measured by a slaking water temperature sensor 58. The slaking water then flows through a slaking water flow control valve 60 from which the slaking water then flows into the slaking water input line 26.

The process water is drawn from a first process water source 40 through a first process water pressure control valve 42, the pressure of the process water being sensed by a first process water pressure gauge 44 and the temperature of the process water is monitored by a process water temperature sensor 48. The process water flows through a process water control valve 46 into a first process water supply line 50 and then through a process water metering valve 52 and then to the wye joint 54 for mixing with preheat water.

Signals from the slaking water temperature sensor 58 and the process water temperature sensor 48 are transmitted to a control device 100. The respective signals are compared and used to control the preheat water metering valve 36 and the process water metering valve 52 to provide slaking water to the slaking vessel 20 at a predefined initial target temperature to slake the lime. In another embodiment of the invention, the temperature of the slaking water is measured by the slaking water temperature sensor 58 and the proportion of process water mixed with the preheat water drawn from the second compartment 30 is adjusted to achieve a target temperature.

In another embodiment of the present invention, slaked lime from the slaking vessel is transferred through the slaked lime transfer line 28 to a mixing tank or third compartment 82 of a lime slurry aging vessel 80 which itself is jacketed with a lime slurry aging water jacket or fourth compartment 84. A second process water source 90 is provided, such that process water flows through a second process water pressure control valve 92 and a second process water control valve 96 to the input of the slurry aging vessel water jacket 84, where the process water is warmed by residual heat released by the slaked lime slurry in the lime slurry aging vessel 80. The heated process water is then discharged from the slurry aging vessel water jacket 84 to the slaking vessel preheat water input line 32. Aged lime slurry is discharged from the slurry aging vessel 80 through an aged slurry outlet line 86 for subsequent use, while the pressure of the process water from a second process water source is monitored by a respective second process water pressure gauge 94.

The apparatus for slaking lime 10 further includes a control device 100 such as a programmable logic controller for sensing the temperature of the slaking water over a line 102 and the temperature of the process water over a line 104 and comparing the temperature of the slaking water with a predetermined target temperature, and further for controlling the operation of the preheat water metering valve 36 and/or the process water metering valve 52 to achieve the desired target temperature.

The present invention permits a target slaking temperature to be obtained throughout the seasons. In particular, during summer months the temperature of preheated water drawn from the second compartment may exceed the target temperature, and can be reduced by addition of process water, which is typically at ambient temperature or lower.

Various modifications can be made in the details of the various embodiments of the apparatus and methods of the present invention, all within the scope and spirit of the invention as defined by the appended claims.

1. A process for slaking lime, the process comprising:
a) providing a slaking vessel having a first compartment and a second compartment, wherein the first and second compartments are disposed to permit heat exchange between the compartments,
b) mixing slaking water with lime in the first compartment,
c) providing input water to the second compartment, whereby heat generated by the exothermic slaking of lime in the first compartment is transferred to the input water,
d) drawing water heated in the second compartment,
e) providing process water,
f) mixing the water heated in and drawn from the second compartment with the process water to provide a mixture,
g) measuring the temperature of the mixture,
h) adjusting the proportion of process water in the mixture to provide water at a target temperature, and
i) providing the water at the target temperature to the first compartment to slake the lime.

2. The process of claim 1 wherein the first compartment of the slaking vessel has an exterior surface and the second compartment jackets at least a portion of the exterior surface of the first compartment.

3. The process of claim 1 further comprising heating the water input to the second compartment.

4. The process of claim 3 further comprising providing a slurry aging tank having a third compartment for receiving slaked lime from the first compartment and a fourth compartment for circulating water, the third and fourth compartments being disposed to permit heat exchange between the third and fourth compartments, the process further comprising transferring slaked lime from the first compartment to the third compartment.

5. The process according to claim 4 further comprising providing process water to the fourth compartment, wherein heat generated by the aging lime slurry is transferred to the process water in the fourth compartment.

6. The process according to claim 5 further including drawing process water heated in the fourth compartment and providing the water drawn from the fourth compartment to the second compartment.

7. The process according to claim 1 further including providing a mixing device for the water drawn from the second compartment and the process water.

8. The process according to claim 1, further comprising measuring the temperature of the process water.

9. The process according to claim 8 further including controlling the flow of process water provided to the mixing device, based on the temperature of the water drawn from the second compartment and the temperature of the process water, and flow rate of the water drawn from the second compartment.

10. Apparatus for slaking lime, the apparatus comprising:
a) a slaking vessel having a first compartment for slaking lime with water and a second compartment having a fluid input and a fluid output, the first and second compartments being disposed to permit heat exchange between the compartments, such that heat generated by the exothermic slaking of lime is transferred to fluid in the second compartment,
b) means for drawing water from the second compartment,
c) means for providing process water,
d) optional means for measuring the temperature of the process water,
e) means for comparing the temperature of the water drawn from the second compartment with the temperature of the process water,
f) means for mixing the water drawn from the second compartment with the process water,
g) optional means for adjusting the flow rate of water drawn from the second compartment,
h) means for adjusting the flow rate of process water,
i) means for determining the proportion of process water being mixed with the water drawn from the second compartment required to provide slaking water having a target temperature, and
j) means for providing the slaking water to the first compartment.

11. The apparatus of claim 10 wherein the first compartment comprises a mixing vessel and the second compartment comprises a jacket enveloping at least a portion of the mixing vessel.

12. The apparatus of claim 10 wherein the means for measuring the temperature of the mixture of water drawn from the second compartment and the process water comprises a thermocouple.

13. The apparatus of claim 10 wherein means for measuring the temperature of the process water comprises a thermocouple.

14. The apparatus of claim 10 wherein the means for mixing the water drawn from the second compartment with the process water comprises a wye joint.

15. The apparatus of claim 10 further comprising a lime slurry aging tank, the slurry aging tank including a third compartment for receiving slaked lime from the first compartment and a fourth compartment for receiving process water, the third and fourth compartments being disposed to permit heat exchange between the third and fourth compartments.

16. The apparatus of claim 15 further comprising means for providing process water to the fourth compartment.

17. The apparatus of claim 15 further comprising means for transferring process water from the fourth compartment to the second compartment.

18. The apparatus of claim 10 further comprising a control device for monitoring the temperature of the mixture of water drawn from the second compartment, and controlling the operation of the means for adjusting the flow rate of water drawn from the second compartment and/or the means for adjusting the flow rate of process water, based on the temperature of the mixture of water drawn from the second compartment and the process water.

19. The apparatus of claim 10 further comprising a control device for monitoring the temperature of the mixture of water drawn from the second compartment, and the temperature of the process water, and for controlling the operation of the means for adjusting the flow rate of water drawn from the second compartment and/or the means for adjusting the flow rate of process water, based on comparison of the temperature of the mixture of water drawn from the second compartment and the process water, and the temperature of the process water.
